(19) United States
(12) Patent Application Publication
(10) Pub. No.: US 2005/0274255 A1
(43) Pub. Date: Dec. 15, 2005

(54) Adjustable ring positioner

(76) Inventor: William R. Hamilton, Severna, MD (US)

Correspondence Address: Clyde I. Coughenour, 16607 Sutton Place, Woodbridge, VA, 22191, US

(21) Appl. No.: 10/866,791

(22) Filed: Jun. 15, 2004

(51) Int. Cl. F15B 15/26

(52) U.S. Cl. 92/128

(57) ABSTRACT

A ring positioning device has positioning elements radially adjustable on a support to fit different diameter cylinder bores. The positioning elements slide in channels in the support and are clamped to the support by knobs that have threaded shafts that slide in slots through the support and are threaded into the positioning elements to clamp them to the support. The positioning elements have protrusions or shoulders that engage the cylinder block deck and lower abutment surfaces that position piston rings in the cylinder bore. A second embodiment uses pivoted arms to adjust for different cylinder bore size with threaded rods on the arms to adjust for different depth ring placement.

### BACKGROUND OF THE INVENTION

1. Field of the Invention

The present invention is to a tool for positioning a piston ring within a cylinder for accurately measuring the gap of a piston ring.

2. Description of Related Art

Piston rings are routinely gapped by placing the ring within the worn cylinder bore with the ends of the ring spacing measured by a feeling gauge or other measuring means. The ends of the ring are filed until the appropriate gap is obtained. The rings are then placed on the piston and the piston inserted into the cylinder bore.

Examples of piston ring alinement in a cylinder include using a flat head piston upside down to push the ring into the cylinder bore. Since not all pistons are flat and since pistons are smaller than the bores they operate in, devices are used to provide a “uniform square” between the ring and bore walls for 360 degrees around the cylinder bore. H. Lanigan, U.S. Pat. No. 2,648,136, issued 11 Aug. 1953, uses a sleeve with holes along its length and a rod to position a ring at different depths in a cylinder block. J. Huggins, U.S. Pat. No. 5,038,449, issued 13 Aug. 1991, provides a one-piece tool for positioning a piston ring in a cylinder and means for guiding a file, to file piston rings positioned on the tool. J. Foster, U.S. Pat. No. 6,421,930, issued 23 Jul. 2002, teaches a piston ring locator having a resilient ring biased outwardly with overlapping ends for insertion into a cylinder bore with outward projections on the upper end for contacting the cylinder block and lower abutment surface for positioning a piston ring in the cylinder bore.

### SUMMARY OF THE INVENTION

A ring positioning device has a support with equally spaced radially adjustable positioning elements guided in and out from the support center in alinement channels in the support lower surface. The positioning elements have uniform width upper surfaces that slide within essentially the same width support alinement channels. The support is provided with radial slots associated with the alinement channels through which the threaded shaft of locking knobs extend into the top of the positioning elements. The knobs diameters are larger than the slot width and secure the positioning elements in a desired location by clamping the positioning element to the support. The outer extent of the positioning element has an upper protrusion or shoulder with a cylinder block or deck engaging lower surface and precisely spaced bottom abutting surface for engagement with and positioning of a piston ring within the cylinder bore. A handle on the support upper surface provides easy manipulation of the ring positioning device.

A second embodiment uses pivot arms with clamps, for securing one end of the pivot arms to the support, and second ends with threaded rods, for locating the piston rings within a cylinder. The outer bottom end of the pivot arms abut the deck. The ring positioning device adjusts to the cylinder bore size by swinging the pivot arms out and adjusts to the depth the ring is to be placed within a cylinder bore by screwing the rods in and out.

### BRIEF DESCRIPTION OF THE DRAWINGS

FIG. 1 is a perspective view of a ring positioning device in accordance with the present invention.

FIG. 2 is a side plan view of the ring positioning device of FIG. 1 with a section broken out.

FIG. 3 is a top plan view of the ring positioning device of FIG. 1.

FIG. 4 is a perspective view of a second embodiment of the ring positioning device.

### DESCRIPTION OF THE PREFERRED EMBODIMENTS

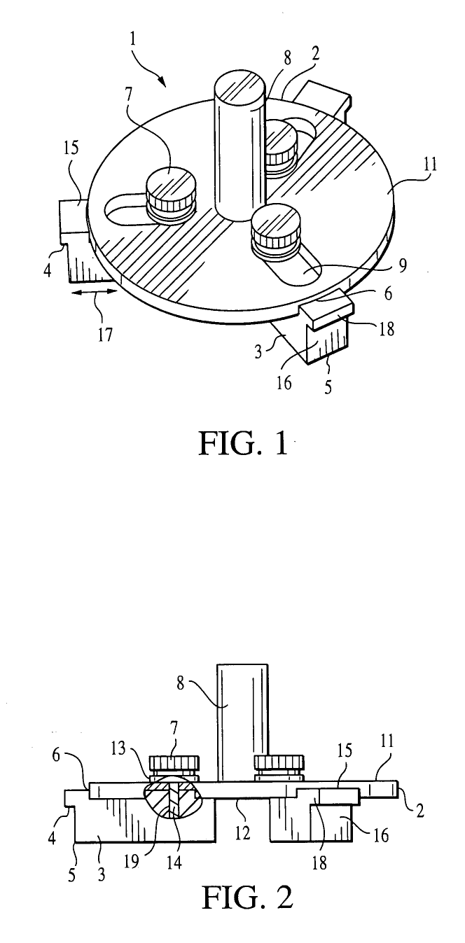

Referring to the drawings, FIG. 1 is a perspective view of a ring positioning device 1 according to the present invention. A circular disk shaped support 2 having a top surface 11 and lower surface 12 is provided with radially equally spaced alinement channels 6 in its lower surface and slots 9 that extend through the support associated with each alinement channel, preferably essentially centrally located with the alinement channels 6 on the support lower surface 12. A handle 8 is positioned on the support 2 upper central surface area 11 for manipulating the ring positioning device 1. Three positioning elements 3 are shown but other numbers may be used. The positioning elements 3 have an upper surface 15 with a width that is essentially the same as that of the alinement channel 6 in the support 2 so that they can slide radially therein. The outer ends of the positioning elements have upper protrusions or shoulders 18 that extend outward beyond the positioning element cylinder inserted outer surface 16. The upper protrusion or shoulder 18 has a lower surface 4 that engages the cylinder block or deck surface to limit the positioning element extension lower bottom or abutment surface 5 extension into a cylinder bore. A threaded recess 19 in the positioning element is provided for securing the positioning elements to the support 2. The positioning elements slide radially 17 inwardly toward and outwardly from the support 2 center for adjusting the positioning elements outer surfaces 16 to fit closely within the cylinder bores of cylinders having different size pistons. After the positioning elements are adjusted to a given size cylinder bore they are locked in position on the support 2 by locking knobs 7. The locking knobs are larger than the slots 9 in the support 2. The knobs have lined, knurled or otherwise roughened surfaces for gripping. Wing nuts or other elements can be used to clamp the positioning elements at a selected position. As seen in the broken out section of FIG. 2, a threaded shaft 14 is secured in the bottom of the knob and threads into the threaded recess 19 in the positioning elements 3 to selectively clamp the positioning elements to the support. A washer 13 is provided between the knobs and the support to provide wear reduction and clamping force over a wider area.

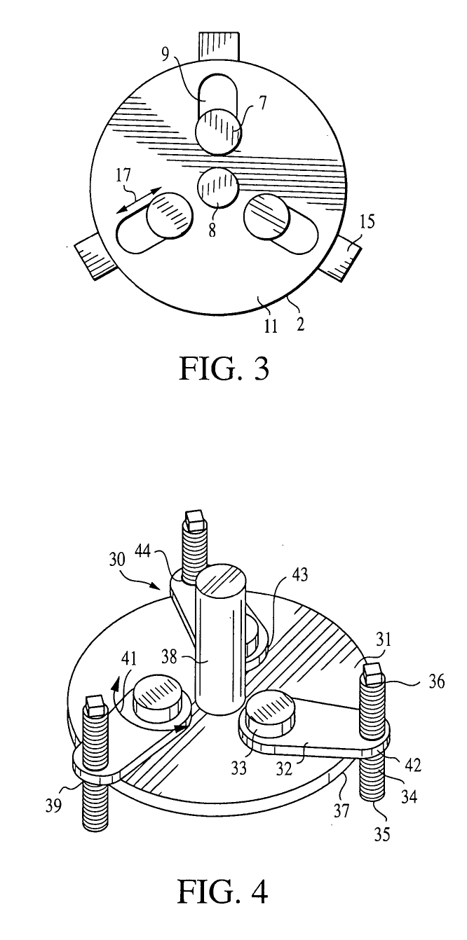

FIG. 4 is a modified version of the embodiment of FIGS. 1-3. Rather than sliding in and out 17 to increase the spacing between the positioning elements outer extent as seen in the ring positioning device 1, the pivot ring positioning device 30 is provided with pivot arms 32 held on pivot support 31. The inner ends 43 of the arms are pivotably secured to the support 31 by, for example, lock knobs 33. The outer ends 42 of the arms support threaded rods 34 and the arms 32 are pivotable 41 to abut the threaded rods with the support outer circumference 37 and away from it. This movement can shift threaded rods 34 from a minimum separation, abutment with the support outer circumference 37, to a maximum distance from the support outer circumference, when the pivot arms are perpendicular to the support outer circumference. The radius of the outer arm end 42 is larger than that of the threaded rods 34 that pass through the pivot arms outer end. This provides enough surface area 39 on the outer lower surface of the pivot arm to engage the cylinder block or deck with the threaded rods 34 lower ends 35 extending into a cylinder bore for positioning piston rings. The knobs 33, or wing nuts, etc., are provided with a threaded shaft that threads into threaded apertures in the support 31, similar to the shafts 17 and recesses 19 of FIG. 2. By loosening the knobs 33, the pivot arms 32 can be turned 41 to adjust the distance the arms outer ends 42 and threaded rods 34 extend outward from the support outer circumference 37 for use with different diameter cylinder bores. When the pivot arms are in the desired position, they may be clamped in that position by tightening the knobs 33. The pivot ring positioning device 30 can be used with a piston bore having a diameter anywhere from slightly larger than the outer circumference 37 of the pivot ring positioning device 30 to the diameter where the pivot arms 32 are perpendicular to their outer circumference 37. Different length pivot arms 32 may be used. The threaded rod 34 is threaded through the threaded passage adjacent the outer radius 42 of the pivot arm 32. The threaded rod lower end 35 can be raised or lowered to control the depth the piston ring is placed in the cylinder bore. The distance the lower surface 35 extends below the pivot arm 32 is adjusted by turning the threaded rod 34, such as by using a square tipped upper end 36. A handle 38 is used to manipulate the pivot ring positioning device 30.

It is believed that the construction, operation and advantages of this invention will be apparent to those skilled in the art. It is to be understood that the present disclosure is illustrative only and that changes, variations, substitutions, modifications and equivalents will be readily apparent to one skilled in the art and that such may be made without departing from the spirit of the invention as defined by the following claims.

1. An adjustable ring positioning device comprising:
a support;
positioning elements on said support;
said positioning elements each including a cylinder deck engaging shoulder and spaced bottom abutment surface;
means for adjusting the spacing between said positioning elements on said support for insertion into different size openings.

2. An adjustable ring positioning device as in claim 1 including:
releasable clamping means secured to said positioning elements for releasably securing said positioning element to said support.

3. An adjustable ring positioning device as in claim 2 including:
slots in said support for adjustably guiding said positioning elements releasable clamping means.

4. An adjustable ring positioning device as in claim 1 wherein:
said positioning elements upper end has a constant width;
support channels in said support have a width essentially the same as the width of said position elements upper end for slidably receiving said positioning elements.

5. An adjustable ring positioning device as in claim 4 including:
releasable clamping means secured to said positioning elements for releasably securing said positioning elements to said support.

6. An adjustable ring positioning device as in claim 5 including:
slots in said support for adjustably guiding said positioning elements releasable clamping means.

7. An adjustable ring positioning device as in claim 1 including:
a support handle centrally located on said support.

8. An adjustable ring positioning device as in claim 2 wherein:
said releasable clamping means includes knobs threaded into said positioning elements.

9. An adjustable ring positioning device as in claim 3 wherein:
said releasable clamping means includes knobs threaded into said positioning elements.

10. An adjustable ring positioning device as in claim 1 including:
three positioning elements equally spaced around said support.

11. An adjustable ring positioning device as in claim 10 wherein:
said positioning elements upper end has a constant width;
support channels in said support have a width essentially the same as the width of said position elements upper end for slidably receiving said positioning elements.

12. An adjustable ring positioning device as in claim 11 including:
releasable clamping means secured to said positioning elements for releasably securing said positioning elements to said support.

13. An adjustable ring positioning device as in claim 12 including:
slots in said support for adjustably guiding said positioning elements releasable clamping means.

14. An adjustable ring positioning device as in claim 13 including:
a support handle centrally located on said support.

15. An adjustable ring positioning device as in claim 14 wherein:
said releasable clamping means includes knobs threaded into said positioning elements.

16. An adjustable ring positioning device as in claim 1 wherein:
said positioning elements are pivot arms having first inner ends and second outer ends;
said pivot arms first inner ends are pivotably attached to said support.

17. An adjustable ring positioning device as in claim 16 including:
threaded rods secured in said pivot arms outer second ends.

18. An adjustable ring positioning device as in claim 17 wherein:
said pivot arms pivot around said first inner ends to adjust said ring positioning device to different size piston bores;
said threaded rods are adjustable in said pivot arms outer ends to adjust the distance that piston rings can be placed in piston bores.

19. An adjustable ring positioning device as in claim 18 wherein:
threaded clamping means are attached to said support through said positioning elements first inner ends that can be loosened, to allow said pivot arms to rotate to a selected position, and that can be tightened, to secure said pivot arms in the selected position.

20. An adjustable ring positioning device as in claim 17 wherein:
said pivot arms second outer ends have a radius that is greater than that of said threaded rods for abutting said pivot arms second outer ends lower surface against the deck of a cylinder block.
